(19) United States
(12) Patent Application Publication
(10) Pub. No.: US 2017/0008763 A1
(43) Pub. Date: Jan. 12, 2017

(54) APPARATUS FOR PRECOOLING AND PURIFYING HYDROGEN

(71) Applicant: KOREA INSTITUTE OF SCIENCE AND TECHNOLOGY, Seoul (KR)

(72) Inventors: Sarng Woo KARNG, Seoul (KR); In Hwan OH, Seoul (KR)

(21) Appl. No.: 14/957,856

(22) Filed: Dec. 3, 2015

(30) Foreign Application Priority Data
Jul. 9, 2015 (KR) 10-2015-0097857

(51) Int. Cl. C01B 3/00; B01D 53/04; B01D 50/00; C01B 3/56; B01D 45/16

(52) U.S. Cl. CPC C01B 3/0089; C01B 3/56; B01D 45/16; B01D 50/002; B01D 53/04; C01B 2203/042; B01D 2256/16

(57) ABSTRACT

Disclosed herein is an apparatus for precooling and purifying hydrogen including a body which includes a first chamber and a second chamber disposed in the first chamber with the second chamber being filled with a liquid cooling medium, a first cyclone chamber disposed in the second chamber and connected to a hydrogen supply pipe on an upper of one side thereof to allow the hydrogen which flows therein to move downward rotating to perform thermal exchange with the cooling medium and separation of impurities therefrom, a first hydrogen discharge pipe to allow hydrogen to flow from the first cyclone chamber to the outside, and an ortho-para hydrogen converting catalyst disposed on a path through which hydrogen which flows in the first hydrogen discharge pipe moves to allow ortho-para hydrogen conversion to be performed.

### CROSS-REFERENCE TO RELATED APPLICATION

This application claims priority to and the benefit of Korean Patent Application No. 2015-0097857, filed on Jul. 9, 2015, the disclosure of which is incorporated herein by reference in its entirety.

### BACKGROUND

1. Field of the Invention

The present invention relates to an apparatus for precooling and purifying hydrogen, and more specifically, for purifying low-purity hydrogen into high-purity hydrogen while performing precooling and ortho-para catalytic conversion.

2. Discussion of Related Art

Generally, to solve air pollution and global warming caused by excessive consumption of fossil fuels, recently, research for using nonhydrocarbonaceous fuel has been active at home and abroad. As a representative method among methods for solving such problems, the most efficient one is use of hydrogen energy.

Since hydrogen energy emits only water with no carbon dioxide and hydrogen may be obtained again from the water, unlike hydrocarbonaceous energy, it may be classified as a renewable energy source.

Hydrogen is generally used as a raw material for chemicals and process gases in chemical plants and recently as a raw material for fuel cells which correspond to a future energy technology. Also, hydrogen is rated as the only alternative energy source with as much potential to solve immediate environmental problems and price rises and depletion of fossil fuels.

To more efficiently use hydrogen energy, it is necessary to prepare high-purity hydrogen by separating and purifying hydrogen.

### SUMMARY OF THE INVENTION

It is an aspect of the present invention to provide an apparatus for precooling and purifying hydrogen capable of precooling hydrogen using a liquid cooling medium, solidifying impurities mixed in the hydrogen, and settling the impurities for filtering using a cyclone effect, thereby improving hydrogen purification efficiency.

It is another aspect of the present invention to provide an apparatus for precooling and purifying hydrogen capable of effectively precooling hydrogen at a temperature of a liquid cooling medium and performing ortho-para hydrogen conversion, thereby producing hydrogen at a high parahydrogen ratio.

According to an aspect of the present invention, there is provided an apparatus for precooling and purifying hydrogen including a body, a first cyclone chamber, a first hydrogen discharge pipe, and an ortho-para hydrogen converting catalyst. The body includes a first chamber and a second chamber installed in the first chamber with an insulating layer between an outer circumferential surface of the second chamber and an inner circumferential surface of the first chamber. The second chamber is filled with a liquid cooling medium. The first cyclone chamber is installed in the second chamber and configured to have a hopper-shaped lower portion. A hydrogen supply pipe is connected to an upper portion of one side of the first cyclone chamber to allow hydrogen to be supplied from the outside of the body to the inside of the first cyclone chamber. The hydrogen introduced on the inside moves downward rotating to perform thermal exchange with the cooling medium and separation of impurities therefrom. The first hydrogen discharge pipe is disposed in a central portion of the first cyclone chamber. The first hydrogen discharge pipe is configured to have a lower end located adjacent to an internal bottom end of the first cyclone chamber and extends upward. The hydrogen which has moved downward in the first cyclone chamber moves through the lower end of the first hydrogen discharged pipe and flows upward through the first hydrogen discharge pipe. The ortho-para hydrogen converting catalyst is disposed in a path in the second chamber. The hydrogen which flows in the first hydrogen discharge pipe moves through the path. The ortho-para hydrogen converting catalyst allows the ortho-para conversion to be performed while the hydrogen moves in contact with the ortho-para converting catalyst.

The apparatus for precooling and purifying hydrogen may include a second cyclone chamber connected to the first hydrogen discharge pipe and a second hydrogen discharge pipe, and, the second cyclone chamber and the second hydrogen discharge pipe define the path. Here, the ortho-para hydrogen converting catalyst may be disposed in the second hydrogen discharge pipe through which the hydrogen is discharged from the second cyclone chamber to the outside of the second cyclone chamber.

At least a part of a hopper-shaped lower portion of the second cyclone chamber may be disposed inside the first cyclone chamber, and an upper portion of the first hydrogen discharge pipe and an upper portion of one side of the second cyclone chamber are connected through a connection pipe to allow the hydrogen to flow from the first hydrogen discharge pipe to the second cyclone chamber. The hydrogen introduced through the connection pipe into the second cyclone chamber flows downward rotation. The second hydrogen discharge pipe may be located to allow a lower end thereof to be adjacent to an internal bottom end of the second cyclone chamber, wherein the hydrogen which has moved downward in the second cyclone chamber flows through the lower end of the second hydrogen discharge pipe and flows the outside.

The first hydrogen discharge pipe is disposed inside the first cyclone chamber and the lower portion of the second cyclone chamber is coupled with a closed top end of the first hydrogen discharge pipe.

A purifying adsorbent may be installed inside the first hydrogen discharge pipe.

A impurity filter for filtering out the impurities may be disposed in the first cyclone chamber.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawing, in which:

FIG. 1 is a cross-sectional view of an apparatus for precooling and purifying hydrogen according to an embodiment of the present invention.

### DETAILED DESCRIPTION OF EXEMPLARY EMBODIMENTS

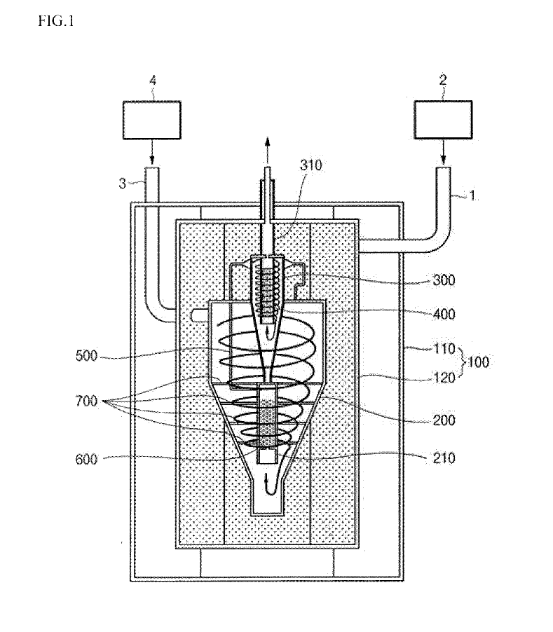

Hereinafter, embodiments of the present invention will be described in detail with reference to FIG. 1.

As shown in FIG. 1, an apparatus for precooling and purifying hydrogen includes a body 100 which includes a first chamber 110 and a second chamber 120 filled with a liquid cooling medium, a first cyclone chamber 200, a second cyclone chamber 300, and an ortho-para hydrogen converting catalyst 400.

The second chamber 120 is accommodated in the first chamber 110 and has a cylindrical shape. An insulating layer such as a vacuum-insulating layer is formed between an inner circumferential surface of the first chamber 110 and the second chamber 120 to insulate the second chamber 120 from the outside.

The second chamber 120 is filled with the liquid cooling medium to precool hydrogen which flows into the first cyclone chamber 200 at a temperature of the cooling medium. Here, liquid nitrogen may be used as the cooling medium in the second chamber 120.

Since the liquid nitrogen is liquefied at 77 K under atmospheric pressure, when the liquid nitrogen is used as the liquid cooling medium, a temperature of the hydrogen may be lowered to 77 K through thermal exchange.

The liquid nitrogen is supplied from a nitrogen tank 2 through a cooling medium supply pipe 1 connected to one side of the second chamber 120 to fill the second chamber 120.

The first cyclone chamber 200 is installed in the second chamber 120. The first cyclone chamber 200 has a cylindrical upper portion and a hopper-shaped lower portion which tapers downward and receives hydrogen from a hydrogen tank 4 through a hydrogen supply pipe 3 connected to one side of the upper portion.

A first hydrogen discharge pipe 210 is installed in the first cyclone chamber 200. The first hydrogen discharge pipe 210 is disposed in a central portion of the first cyclone chamber 200, and a bottom end thereof is disposed adjacent to a bottom end of the first cyclone chamber 200 and extends upward.

Accordingly, the hydrogen supplied from the hydrogen supply pipe 3 causes a cyclone in the first cyclone chamber 200 and simultaneously moves downward with a rotating flow and is cooled to 77 K which is the temperature of the liquid nitrogen through thermal exchange with the liquid nitrogen and then is discharged through the first hydrogen discharge pipe 210.

The hydrogen is cooled to the temperature of the liquid nitrogen, and the impurities mixed in the hydrogen solidify and settle on a bottom of the first cyclone chamber 200.

Here, in the first cyclone chamber 200, a plurality of impurity filters 700 are arranged in a column in a horizontal direction in the hopper-shaped lower portion. Accordingly, low-purity hydrogen supplied through the hydrogen supply pipe 3 from the hydrogen tank 4 passes through the plurality of impurity filters 700 to filter out impurities. The impurity filter 700 may be plate-type mesh net.

A purifying adsorbent 600 such as zeolite is installed in the first hydrogen discharge pipe 210. Accordingly, the hydrogen purified in the first cyclone chamber 200 is purified again by the purifying adsorbent 600 to increase purification efficiency.

According to the embodiment of the present invention, the second cyclone chamber 300 connected to the first cyclone chamber 200 is included in the second chamber 120.

The second cyclone chamber 300 is formed to be smaller than the first cyclone chamber 200, and a hopper-shaped lower portion thereof is located in a central portion of the first cyclone chamber 200 and penetrates a top end of the first cyclone chamber 200 to extend into the second chamber 120. That is, the second cyclone chamber 300 is disposed in the second chamber 120 in such a way that the hopper-shaped lower portion thereof is entirely or partially located inside the first cyclone chamber 200 and an upper portion thereof is located outside the top end of the first cyclone chamber 200.

The first hydrogen discharger pipe 210 is disposed in the first cyclone chamber 200 and the lower portion of the second cyclone chamber 300 is coupled with a closed top end of the first hydrogen discharge pipe 210. Due to this, the first hydrogen discharge pipe 210 may be supported in the first cyclone chamber 200.

The top end of the first hydrogen discharge pipe 210 and a top end of the second cyclone chamber 300 are connected through a connection pipe 500 in such a way that the hydrogen which passes through the first cyclone chamber 200 flows into the top end of the second cyclone chamber 300 through the first hydrogen discharge pipe 210. Since the connection pipe 500 has a smaller cross section than the first hydrogen discharge pipe 210 and the second cyclone chamber 300, a Venturi effect occurs. That is, when the hydrogen flows from the first hydrogen discharge pipe 210 of the first cyclone chamber 200 to the second cyclone chamber 300 through the connection pipe 500, flow velocity of the supplied hydrogen becomes higher due to a difference in diameter. The hydrogen with the high flow velocity as described above maintains a velocity identical to the velocity when passing the second cyclone chamber 300 with a great diameter, thereby causing a low pressure state in the connection pipe 500 which is a Venturi pipe.

Accordingly, the hydrogen which flows through the first hydrogen discharge pipe 210 of the first cyclone chamber 200 automatically flows into the connection pipe 500. The hydrogen which flows into the connection pipe 500 as described above is automatically discharged toward the second cyclone chamber 300 at a high speed

The hydrogen which flows at a high speed into the second cyclone chamber 300 is purified as in the first cyclone chamber 200 and is discharged through a second hydrogen discharge pipe 310.

The second hydrogen discharge pipe 310 is disposed in a central portion of the second cyclone chamber 300, and a bottom end thereof is disposed adjacent to a bottom end of the second cyclone chamber 300 and extends upward. The second hydrogen discharge pipe 310 is connected to a pipe for discharging hydrogen from the first chamber 110.

Here, the ortho-para hydrogen converting catalyst 400 is installed to perform ortho-para hydrogen conversion of the hydrogen in relation to hydrogen liquefaction in the second hydrogen discharge pipe 310.

Hydrogen molecules exist in two molecular structures of orthohydrogen and parahydrogen. Equilibrium composition of the orthohydrogen and parahydrogen differs depending on temperature. 25% parahydrogen and 75% orthohydrogen are in equilibrium at room temperature. At 20 K that is a liquefaction temperature, parahydrogen becomes 99.8%.

However, conversion from orthohydrogen into parahydrogen is an exothermic reaction and is performed very slowly over several tens of hours to several tens of days. Accordingly, when hydrogen is liquefied by lowering a temperature thereof without ortho-para hydrogen conversion, since heat of about 527 kJ/kg generated when orthohydrogen is converted into parahydrogen in a liquid state is more than evaporative latent heat of about 451.9 kJ/kg necessary for evaporating liquid hydrogen, all the stored liquid hydrogen evaporates and cannot be stored. Accordingly, the ortho-para hydrogen converting catalyst 400 is used to perform ortho-para hydrogen conversion according to temperature drop in a hydrogen liquefaction process, thereby preventing heat generation caused by the ortho-para hydrogen conversion after liquefaction.

Since the ortho-para hydrogen converting catalyst 400 is included in the second hydrogen discharge pipe 310, the second hydrogen discharge pipe 310 serves as a space in which the ortho-para hydrogen conversion of the hydrogen which flows therein occurs. The ortho-para hydrogen converting catalyst 400 may be formed of an ortho-para hydrogen catalyst provided as granules or a mass in the second hydrogen discharge pipe 310. As the ortho-para hydrogen converting catalyst 400, magnetite, chromium oxide, etc. are used.

According to the embodiment of the present invention, in the apparatus for precooling and purifying hydrogen having the configuration described above, ortho-para hydrogen conversion of hydrogen is performed in the presence of the ortho-para hydrogen converting catalyst 400 at a temperature of about 77 K similar to a temperature of a cooling medium, for example, liquid nitrogen.

Equilibrium composition of orthohydrogen and parahydrogen depends on a temperature. According to the embodiment of the present invention, since hydrogen is precooled by a cooling medium before ortho-para hydrogen conversion is performed, the hydrogen discharged through the second hydrogen discharge pipe 310 reaches a high parahydrogen ratio.

The apparatus for precooling and purifying hydrogen according to another embodiment of the present invention may include the first cyclone chamber 200 and the first hydrogen discharge pipe 210 without the second cyclone chamber and the second hydrogen discharge pipe. Here, the first hydrogen discharge pipe 210 may extend through the top end of the first cyclone chamber 200 and may be connected to a pipe for discharging hydrogen outward. In this case, the ortho-para hydrogen converting catalyst 400 may be disposed in the first hydrogen discharge pipe 210 and the first hydrogen discharge pipe 210 define the path in which the ortho-para hydrogen converting catalyst 400 is disposed.

However, according to the apparatus for precooling and purifying hydrogen shown in FIG. 1, the first and second cyclone chambers 200 and 300 are consecutively arranged, thereby increasing purification efficiency and increasing a flow time inside the second chamber 120 to improve precooling efficiency. In addition, according to the apparatus for precooling and purifying hydrogen shown in FIG. 1, the first and second cyclone chambers 200 and 300 may be installed while a size of the second chamber 120 is minimized.

According to the embodiment of the present invention described above, an apparatus for precooling and purifying hydrogen filters out impurities mixed in hydrogen through a cyclone effect while simultaneously performing precooling, thereby simultaneously precooling and purifying the hydrogen.

In addition, since ortho-para hydrogen conversion of hydrogen using an ortho-para hydrogen catalyst is performed after precooling using a liquid cooling medium, hydrogen may be produced at a high parahydrogen ratio.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for precooling and purifying hydrogen comprising:
a body which comprises a first chamber and a second chamber installed in the first chamber with an insulating layer between an outer circumferential surface of the second chamber and an inner circumferential surface of the first chamber, wherein the second chamber is filled with a liquid cooling medium;
a first cyclone chamber installed in the second chamber and connected to a hydrogen supply pipe through which hydrogen is supplied from the outside on an upper portion of one side of the first cyclone chamber, wherein the hydrogen introduced on the inside moves downward rotating to perform thermal exchange with the cooling medium and separation of impurities therefrom;
a first hydrogen discharge pipe disposed in a central portion of the first cyclone chamber, wherein the hydrogen which has moved downward in the first cyclone chamber flows through a lower end of the first hydrogen discharge pipe;
an ortho-para hydrogen converting catalyst disposed in a path in the second chamber, wherein the hydrogen which flows in the first hydrogen discharge pipe moves through the path to allow ortho-para hydrogen conversion to be performed while the hydrogen moves in contact with the ortho-para hydrogen converting catalyst.

2. The apparatus for precooling and purifying hydrogen of claim 1, wherein the first cyclone chamber is configured to have a hopper-shaped lower portion.

3. The apparatus for precooling and purifying hydrogen of claim 1, wherein the path comprises a second cyclone chamber connected to the first hydrogen discharge pipe and a second hydrogen discharge pipe through which the hydrogen is discharged from the second cyclone chamber; and
wherein the ortho-para hydrogen converting catalyst is disposed in the second hydrogen discharge pipe.

4. The apparatus for precooling and purifying hydrogen of claim 3, wherein:
the first hydrogen discharge pipe and an upper portion of one side of the second cyclone chamber are connected through a connection pipe to allow the hydrogen to flow from the first discharge pipe to the second cyclone chamber,
the second cyclone chamber is configured to have a hopper-shaped lower portion and at least a part of the hopper-shaped lower portion of the second cyclone chamber is disposed inside the first cyclone chamber, and
a lower end of the second hydrogen discharge pipe is disposed in the second cyclone chamber to allow the hydrogen which has moved downward in the second hydrogen chamber to flow through the lower end of the second hydrogen discharge pipe.

5. The apparatus for precooling and purifying hydrogen of claim 4, wherein the first hydrogen discharge pipe is disposed inside the first cyclone chamber and the lower portion of the second cyclone chamber is coupled with a closed top end of the first hydrogen discharge pipe.

6. The apparatus for precooling and purifying hydrogen of claim 1, wherein a purifying adsorbent is disposed inside the first hydrogen discharge pipe.

7. The apparatus for precooling and purifying hydrogen of claim 1, wherein at least one impurity filter for filtering out the impurities is disposed in the first cyclone chamber.
